(19) United States
(12) Patent Application Publication
(10) Pub. No.: US 2012/0199422 A1
(43) Pub. Date: Aug. 9, 2012

(54) ELEVATOR APPARATUS

(75) Inventor: Mineo Okada, Tokyo (JP)

(73) Assignee: MITSUBISHI ELECTRIC CORPORATION, Toyota (JP)

(21) Appl. No.: 13/501,360

(22) PCT Filed: Jan. 7, 2010
(86) PCT No.: PCT/JP10/50091

§ 371 Date: Apr. 11, 2012

(51) Int. Cl. B66B 3/00

(52) U.S. Cl. 187/393

(57) ABSTRACT

A speed governor includes: a centrifugal weight that revolves around a predetermined revolving shaft in response to movement of a car; an extensible body to which the centrifugal weight is connected, and that is rotated around the revolving shaft, the extensible body being displaced relative to the revolving shaft in response to a centrifugal force to which the centrifugal weight is subjected due to the revolution; a switching apparatus that extends and retracts the extensible body in response to an elevator operational state; and an operation detecting apparatus that detects whether a state of the extensible body is an extended state in which the extensible body is extended or a retracted state in which the extensible body is retracted. A controlling apparatus determines presence or absence of an abnormality in the speed governor by comparing the elevator operational state and detection results from the operation detecting apparatus.

### TECHNICAL FIELD

The present invention relates to an elevator apparatus that has a car that is moved inside a hoistway.

### BACKGROUND ART

Conventionally, elevator apparatuses have been proposed in which a hoisting machine braking apparatus is operated if a car speed reaches a predetermined shutdown speed, and an emergency stopper apparatus that is disposed on the car is operated if the car speed reaches an emergency overspeed that is higher than the shutdown speed. In these conventional elevator apparatuses, the car speed reaching the shutdown speed is detected by a displacing body in which a rotating shaft is displaced in response to the car speed reaching a position of an overspeed detecting switch. The shutdown speed value is modifiable by changing a position of the overspeed detecting switch. The position of the overspeed detecting switch is changed by an electromagnetic displacing apparatus that has an electromagnet (See Patent Literature 1).

### CITATION LIST

### Patent Literature

### [Patent Literature 1]

WO 2009/093330

### SUMMARY OF THE INVENTION

### Problem to be Solved by the Invention

However, in conventional elevator apparatuses such as that described above, because the position of the overspeed detecting switch is changed by an electromagnetic displacing apparatus that has an electromagnet, there is a risk that an abnormality may occur in the displacement of the overspeed detecting switch due to malfunction of the electromagnetic displacing apparatus due to abrasive deterioration, or a stoppage in supply of electric power to the electromagnet due to wire breakage, etc. If an abnormality of this kind occurs, the position of the overspeed detecting switch may deviate from its original position, making it impossible to set the shutdown speed value to a desired value. In a conventional elevator apparatus such as that described above, another problem has been that it is not possible to modify the value of the emergency overspeed that activates the emergency stopper apparatus.

The present invention aims to solve the above problems and an object of the present invention is to provide an elevator apparatus that can detect an abnormality in a speed governor more reliably.

### Means for Solving the Problem

In order to achieve the above object, according to one aspect of the present invention, there is provided an elevator apparatus characterized in including: a car that is moved inside a hoistway; a speed governor including: a centrifugal weight that revolves around a predetermined revolving shaft in response to the movement of the car; an extensible body to which the centrifugal weight is connected, and that is rotated around the revolving shaft, the extensible body being displaced relative to the revolving shaft in response to a centrifugal force to which the centrifugal weight is subjected due to the revolution; a switching apparatus that extends and retracts the extensible body in response to an elevator operational state; and an operation detecting apparatus that detects whether a state of the extensible body is an extended state in which the extensible body is extended or a retracted state in which the extensible body is retracted, the speed governor detecting presence or absence of an abnormality in speed of the car based on an amount of displacement of the extensible body relative to the revolving shaft; and a controlling apparatus that determines presence or absence of an abnormality in the speed governor by comparing the elevator operational state and detection results from the operation detecting apparatus.

### Effects of the Invention

In an elevator apparatus according to the present invention, because the state of the extensible body is detected as being either the extended state or the retracted state by the operation detecting apparatus, abnormalities in the speed governor can be more reliably detected by comparing the detection results of the operation detecting apparatus and the elevator operational state even if the extensible body cannot perform normal extending and retracting operations. Abnormalities in the speed governor can thereby be detected early, enabling elevator operation to be prevented from being continued when an abnormality occurs in the speed governor.

### BRIEF DESCRIPTION OF THE DRAWINGS

FIG. 1 is a configuration diagram that shows an elevator apparatus according to Embodiment 1 of the present invention;

FIG. 2 is a longitudinal cross section that shows a speed governor from FIG. 1;

FIG. 3 is a longitudinal cross section that shows a state in which extensible bodies of the speed governor from FIG. 2 are extended;

FIG. 4 is a front elevation that shows the speed governor from FIG. 2;

FIG. 5 is a configuration diagram that shows an elevator apparatus according to Embodiment 2 of the present invention;

FIG. 6 is a circuit diagram that shows electrically connected states of respective lower portion position switches, respective upper portion position switches, and a communications device from FIG. 5;

FIG. 7 is a circuit diagram that shows a state in which all of the respective lower portion position switches and the respective upper portion position switches from FIG. 6 have stopped cam detection;

FIG. 8 is a longitudinal cross section that shows a speed governor from FIG. 5;

FIG. 9 is a longitudinal cross section that shows the speed governor from FIG. 5 when a car is outside both the lower end portion region and the upper end portion region; and

FIG. 10 is a graph that shows relationships between normal operating speed, a first set overspeed, and a second set overspeed, respectively, of the car from FIG. 5 and position of the car.

### DESCRIPTION OF EMBODIMENTS

Preferred embodiments of the present invention will now be explained with reference to the drawings.

### Embodiment 1

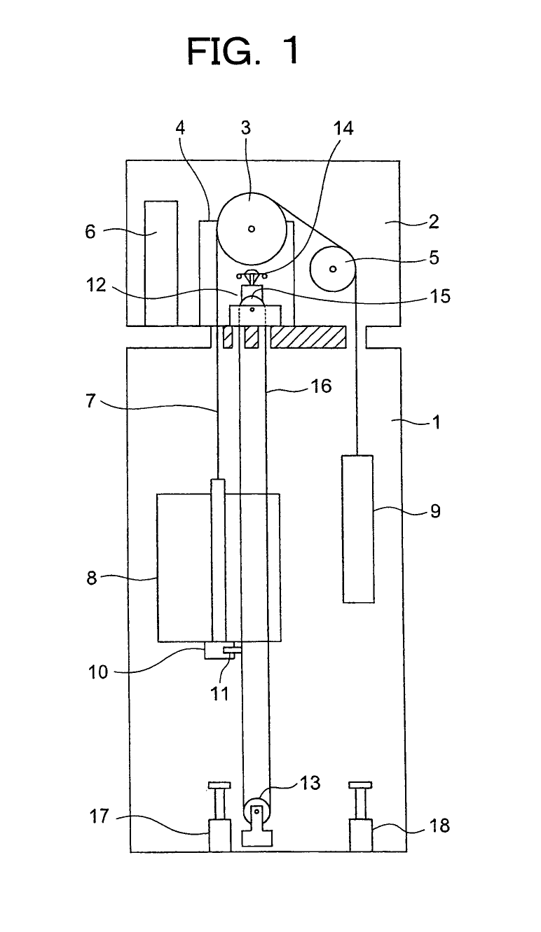

FIG. 1 is a configuration diagram that shows an elevator apparatus according to Embodiment 1 of the present invention. In the figure, a machine room 2 is disposed in an upper portion of a hoistway 1. Disposed inside the machine room 2 are: a hoisting machine (a driving machine) 4 that has a driving sheave 3; a deflecting sheave 5 that is disposed so as to be positioned at a distance from the driving sheave 3; and a controlling apparatus 6 that controls elevator operation.

A common main rope 7 is wound around the driving sheave 3 and the deflecting sheave 5. A car 8 and a counterweight 9 that are raised and lowered inside the hoistway 1 are suspended by the main rope 7. The car 8 and the counterweight 9 are raised and lowered inside the hoistway 1 by rotation of the driving sheave 3. When the car 8 and the counterweight 9 are raised and lowered inside the hoistway 1, the car 8 is guided by car guide rails (not shown), and the counterweight 9 is guided by counterweight guide rails (not shown).

An emergency stopper apparatus 10 that stops falling of the car 8 is disposed on a lower portion of the car 8. An operating arm 11 is disposed on the emergency stopper apparatus 10. The emergency stopper apparatus 10 grips the car guide rails by operation of the operating arm 11. Falling of the car 8 is stopped by gripping of the car guide rails by the emergency stopper apparatus 10.

A speed governor 12 is disposed inside the machine room 2, and a tensioning sheave 13 is disposed in a lower portion inside the hoistway 1. The speed governor 12 has: a speed governor main body 14; and a speed governor sheave 15 that is disposed on the speed governor main body 14. A speed governor rope 16 is wound around the speed governor sheave 15 and the tensioning sheave 13. A first end portion and a second end portion of the speed governor rope 16 are connected to the operating arm 11. The speed governor sheave 15 and the tension sheave 13 are thereby rotated together with the movement of the car 8. The speed governor sheave 15 and the tensioning sheave 13 are rotated forward by ascent of the car 8, and are rotated in reverse by descent of the car 8.

The speed governor main body 14 grips the speed governor rope 16 if rotational speed of the speed governor sheave 15 reaches a predetermined set overspeed (an emergency overspeed). The operating arm 11 is operated by the speed governor rope 16 being gripped by the speed governor main body 14 and the car 8 being displaced relative to the speed governor rope 16.

A car buffer 17 that is positioned below the car 8, and a counterweight buffer 18 that is positioned below the counterweight 9 are disposed in a bottom portion (a pit portion) of the hoistway 1. If subjected to a collision with the car 8, the car buffer 17 relieves mechanical shock that is imparted to the car 8. If subjected to a collision with the counterweight 9, the counterweight buffer 18 relieves mechanical shock that is imparted to the counterweight 9.

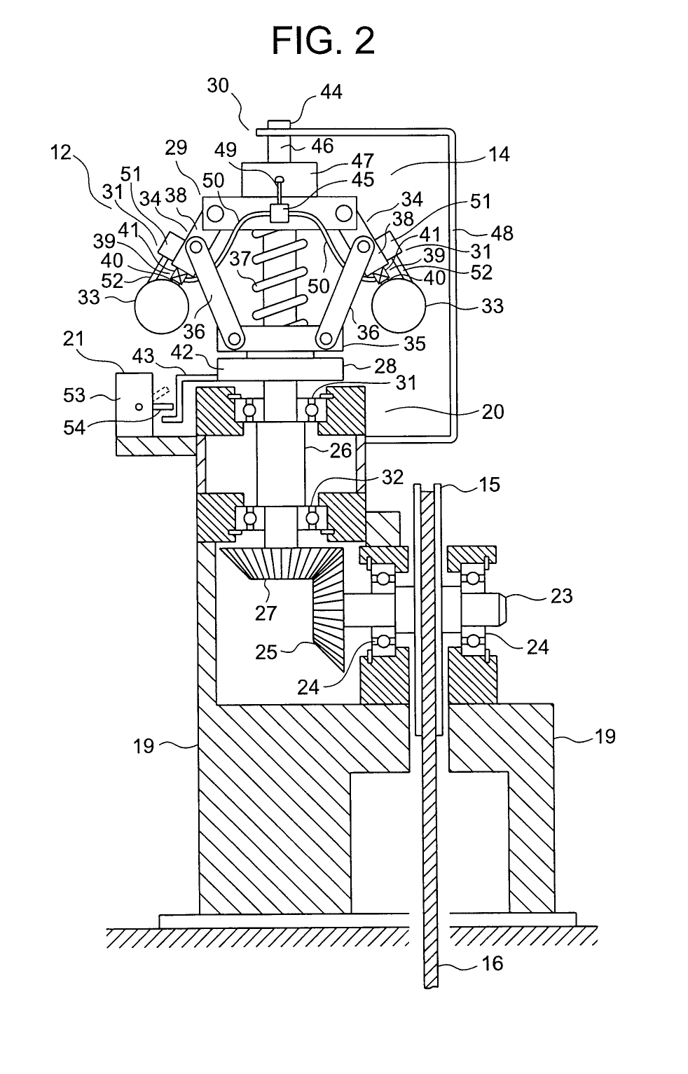

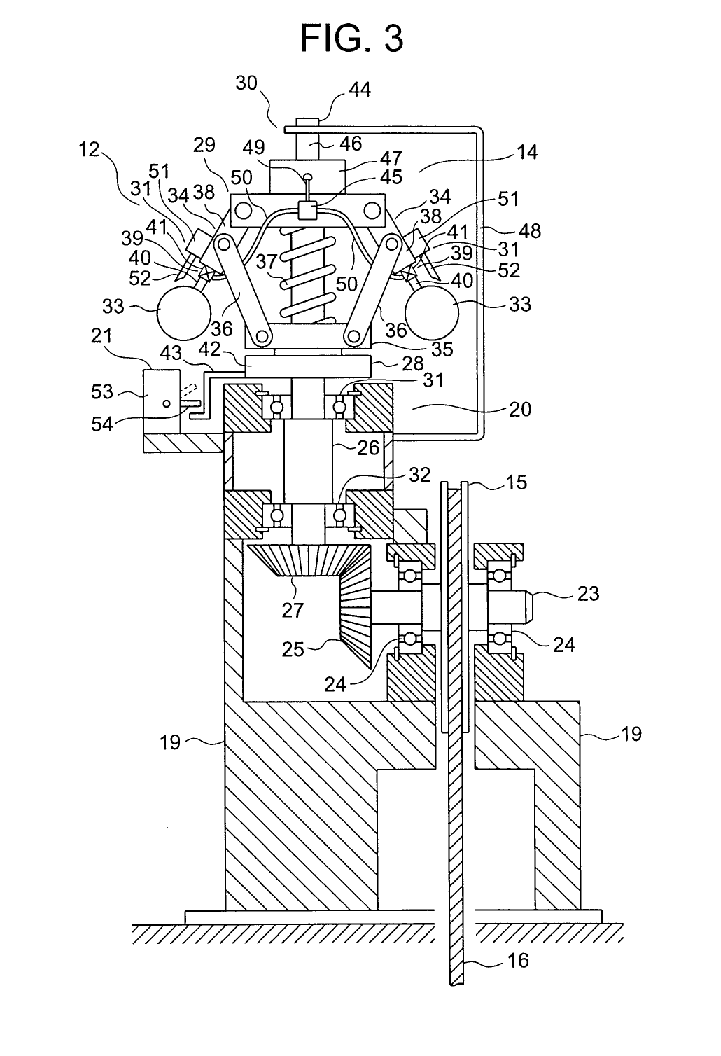

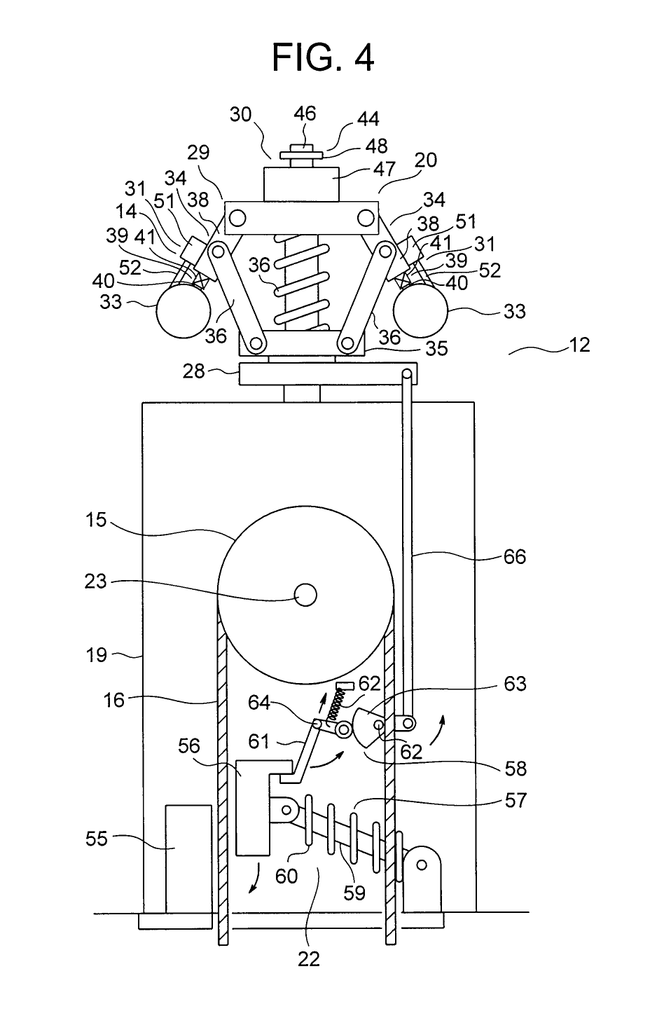

FIG. 2 is a longitudinal cross section that shows the speed governor 12 from FIG. 1. FIG. 3 is a longitudinal cross section that shows a state in which extensible bodies of the speed governor 12 from FIG. 2 are extended. In addition, FIG. 4 is a front elevation that shows the speed governor 12 from FIG. 2. In the figure, the speed governor 12 is supported by a supporting body 19. The speed governor main body 14 has: a sheave interlocking device 20 that operates interdependently with the speed governor sheave 15 in response to rotational speed of the speed governor sheave 15; an overspeed detecting switch 21 that outputs a stopping signal that stops elevator operation on being activated by the sheave interlocking device 20; and a gripping apparatus 22 that grips the speed governor rope 16 on being activated by the sheave interlocking device 20 (FIG. 4).

As shown in FIGS. 2 and 3, a sheave shaft 23 of the speed governor sheave 15 is supported horizontally in the supporting body 19 by means of bearings 24. A driving bevel gear 25 is fixed to an end portion of the sheave shaft 23.

The sheave interlocking device 20 has: a driven shaft (a predetermined revolving shaft) 26 that is disposed so as to be parallel to a vertical direction; a driven bevel gear 27 that is fixed to a lower end portion of the driven shaft 26, and that intermeshes with the driving bevel gear 25; a displacing body 28 that is disposed on the driven shaft 26, and that is displaceable relative to the driven shaft 26 in a direction that is parallel to the driven shaft 26; a centrifugally displacing apparatus 29 that displaces the displacing body 28 in response to the rotation of the driven shaft 26; a switching apparatus 30 that modifies a relationship between the rotational speed of the driven shaft 26 and the amount of displacement of the displacing body 28 by switching the setting of the centrifugally displacing apparatus 29 in response to the operating state of the elevator; and operation detecting switches (operation detecting apparatuses) 31 that detect the switching operation of the setting of the centrifugally displacing apparatus 29 by the switching apparatus 30.

The driven shaft 26 is supported by the supporting body 19 so as to have a bearing 32 interposed. The rotation of the sheave shaft 23 is transmitted to the driven shaft 26 by means of the driving bevel gear 25 and the driven bevel gear 27. Consequently, the driven shaft 26 is rotated in response to the rotation of the speed governor sheave 15. Specifically, the driven shaft 26 is rotated forward during forward rotation of the speed governor sheave 15, and is rotated in reverse during reverse rotation of the speed governor sheave 15.

The centrifugally displacing apparatus 29 is disposed on an upper portion of the driven shaft 26. The centrifugally displacing apparatus 29 is rotated together with the driven shaft 26. In addition, the centrifugally displacing apparatus 29 has: a pair of fly balls (centrifugal weights) 33 that revolve around the driven shaft 26 in response to the rotation of the driven shaft 26; a pair of extensible bodies 34 that are connected to the fly balls 33, and that can rotate around the driven shaft 26; a sliding cylinder 35 that is passed slidably over the driven shaft 26; a pair of linking members 36 that link the respective extensible bodies 34 and the sliding cylinder 35; and a balancing spring 37 that forces the sliding cylinder 35 downward.

The fly balls 33 are subjected to centrifugal forces that correspond to the rotational speed of the driven shaft 26 by revolving around the driven shaft 26.

The extensible bodies 34 are displaced by pivoting relative to the driven shaft 26 in response to the centrifugal forces to which the fly balls 33 are subjected. The sliding cylinder 35 is displaced in a direction that is parallel to the driven shaft 26 in response to the displacement of the respective extensible bodies 34 relative to the driven shaft 26. Specifically, when the rotational speed of the driven shaft 26 increases, the extensible bodies 34 are displaced in a direction in which the fly balls 33 move away from each other, and the sliding cylinder 35 is displaced upward in opposition to force from the balancing spring 37. When the rotational speed of the driven shaft 26 decreases, the extensible bodies 34 are displaced in a direction in which the fly balls 33 move toward each other, and the sliding cylinder 35 is displaced downward by the force from the balancing spring 37.

The respective extensible bodies 34 are constituted by rod-shaped bodies. The extensible bodies 34 each have: an extensible body main body 38 that is mounted so as to be able to pivot relative to the driven shaft 26; and an actuator 39 that is disposed on the extensible body main body 38, and that changes the length of the extensible body 34.

The actuators 39 have: plungers 40 that are displaceable relative to the extensible body main bodies 38; and electromagnetic coils 41 that displace the plungers 40 relative to the extensible body main bodies 38.

The fly balls 33 are mounted to the plungers 40. The plungers 40 are displaceable between: an extended position (FIG. 3) that is away from the extensible body main body 38; and a retracted position (FIG. 2) that is closer to the extensible body main body 38 than the extended position. Length of the extensible bodies 34 is changed by the plungers 40 being displaced between the extended position and the retracted position. In other words, the state of the extensible bodies 34 is changed between an extended state in which the extensible bodies 34 are extended and a retracted state in which the extensible bodies 34 are retracted by displacement of the plungers 40 relative to the extensible body main bodies 38. The state of the extensible bodies 34 is set to the retracted state on passage of an electric current to the electromagnetic coils 41, and is set to the extended state when the passage of electric current to the electromagnetic coils 41 is stopped, due to force from springs (forcing bodies) (not shown).

The displacing body 28 is displaceable together with the sliding cylinder 35. The displacing body 28 is thereby displaced in a direction that is parallel to the driven shaft 26 in response to the rotational speed of the speed governor sheave 15. The displacing body 28 is also rotatable relative to the sliding cylinder 35 and the driven shaft 26. Consequently, the displacing body 28 is not rotated even if the sliding cylinder 35 and the driven shaft 26 are rotated. In addition, the displacing body 28 has: a driven cylinder 42 that is passed slidably over the driven shaft 26; and an operating portion 43 that protrudes outward from an outer circumferential surface of the driven cylinder 42.

The switching apparatus 30 switches the setting of the centrifugally displacing apparatus 29 by extending and retracting each of the extensible bodies 34 in response to an operating state of the elevator that is determined by the direction of movement of the car 8. In other words, the switching apparatus 30 sets the state of the extensible bodies 34 to mutually different states that are the extended state and the retracted state, when the direction of movement of the car 8 is upward (i.e., during forward rotation of the driven shaft 26), and when downward (i.e., during reverse rotation of the driven shaft 26). Thus, the orbital radius of the fly balls 33 is different when the direction of movement of the car 8 is upward from when downward, making the relationship between the amount of displacement of the displacing body 28 and the rotational speed of the driven shaft 26 different.

In this example, the switching apparatus 30 sets the state of the extensible bodies 34 to the retracted state when the direction of movement of the car 8 is upward (i.e., during forward rotation of the driven shaft 26), and sets the state of the extensible bodies 34 to the extended state when the direction of movement of the car 8 is downward (i.e., during reverse rotation of the driven shaft 26).

The switching apparatus 30 has: a generator 44 that generates electric power from the rotation of the driven shaft 26; and a rectifying apparatus 45 that sends electric power to the electromagnetic coils 41 from the electric power that is generated by the generator 44 either only during forward rotation or only during reverse rotation of the driven shaft 26.

The generator 44 is disposed on an upper end portion of the driven shaft 26. The generator 44 is a direct-current generator. In addition, the generator 44 has: a generator fixed shaft 46 that includes permanent magnets; and a generator main body 47 that includes a power generating coil, and that surrounds the generator fixed shaft 46. The generator fixed shaft 46 is mounted to the supporting body 19 by means of a mounting bracket 48. The generator main body 47 is rotated together with the driven shaft 26. Electric current flows through the power generating coil when the generator main body 47 is rotated together with the driven shaft 26. Direction of the electric current that flows through the power generating coil changes depending on the direction of rotation of the driven shaft 26. Specifically, the generator 44 generates a positive electric current during forward rotation of the driven shaft 26, and generates a negative electric current during reverse rotation of the driven shaft 26.

The rectifying apparatus 45 is electrically connected to the generator main body 47 and the electromagnetic coils 41, respectively, by conducting wires 49 and 50. The rectifying apparatus 45 sends either only the positive or only the negative electric current from the generator 44 to the electromagnetic coils 41. The electric power is thereby sent to the electromagnetic coils 41 from the rectifying apparatus 45 either only during forward rotation of the driven shaft 26 or only during reverse rotation.

In this example, only the positive electric current of the positive and negative electric current from the generator 44 (i.e., only the electric current when the direction of movement of the car 8 is upward) is sent from the rectifying apparatus 45 to the electromagnetic coils 41. The negative electric current is shut off by the rectifying apparatus 45, and does not reach the electromagnetic coils 41. Consequently, the state of each of the extensible bodies 34 is set to the retracted state when the direction of movement of the car 8 is upward, and the state of each of the extensible bodies 34 is set to the extended state when the direction of movement of the car 8 is downward.

The operation detecting switches 31 are respectively disposed on the extensible bodies 34. The operation detecting switches 31 detect the switching operation of the setting of the centrifugally displacing apparatus 29 by the switching apparatus 30 by detecting whether the state of the extensible bodies 34 is the extended state or the retracted state.

The operation detecting switches 31 have: switch main bodies (operation detecting apparatus main bodies) 51 that are mounted to the extensible body main bodies 38; and switch movable segments (movable bodies) 52 that are displaceable between an advanced position that protrudes toward the fly balls 33 from the switch main bodies 51 and a regressed position that is closer to the switch main bodies 51 than the advanced position.

The switch movable segments 52 are rod-shaped bodies that are disposed alongside the extensible bodies 34. The switch movable segments 52 are forced toward the advanced position by switch springs (forcing bodies) that are disposed inside the switch main bodies 51 (not shown).

The switch movable segments 52 are separated from the fly balls 33 when the state of the extensible bodies 34 is the extended state. Consequently, when the state of the extensible bodies 34 is the extended state, the switch movable segments 52 are displaced to the advanced position by the forces from the switch springs.

When the extensible bodies 34 are retracted to the retracted state, the fly balls 33 are displaced toward the switch main bodies 51. When the extensible bodies 34 are retracted to the retracted state, the switch movable segments 52 are displaced from the advanced position toward the regressed position in opposition to the forces from the switch springs while being pressed by the fly balls 33.

In other words, the switch movable segments 52 are displaced between the advanced position and the regressed position in response to the expansion and contraction of the extensible bodies 34.

The switch main bodies 51 detect whether the extensible bodies 34 are in the extended state or in the retracted state in response to the displacement of the switch movable segments 52. Specifically, the switch main bodies 51 are in an ON state when the switch movable segments 52 are in a first position of the advanced position and the regressed position, and are in an OFF state when in a second position thereof.

In this example, the switch main bodies 51 are in the ON state when the switch movable segments 52 are in the advanced position, and are in the OFF state when the switch movable segments 52 is in the regressed position. The information that is detected by the switch main bodies 51 is sent from the operation detecting switches 31 to the controlling apparatus 6.

The overspeed detecting switch 21 is disposed radially outside the driven tube 42. The overspeed detecting switch 21 has: a switch main body 53 that is fixed to the supporting body 19; and a switch lever 54 that is disposed on the switch main body 53, and that projects toward the displacing body 28. The operating portion 43 is able to operate the switch lever 54 by displacement of the displacing body 28 relative to the overspeed detecting switch 21. The overspeed detecting switch 21 detects an abnormality in the speed of the car 8 by the switch lever 54 being operated by the operating portion 43. Specifically, the overspeed detecting switch 21 detects the presence or absence of an abnormality in the speed of the car 8 based on the presence or absence of detection of the displacing body 28. A stopping signal that stops elevator operation is output from the switch main body 53 on detection of an abnormality in the speed of the car 8 by the overspeed detecting switch 21.

Because the orbital radius of the fly balls 33 increases when the state of the extensible bodies 34 is the extended state, the displacement of the displacing body 28 is greater than when the state of the extensible bodies 34 is the retracted state. Consequently, when the state of the extensible bodies 34 is the extended state, the displacing body 28 will reach the position at which the switch lever 54 is operated at a stage when the rotational speed of the driven shaft 26 is lower than when the state of the extensible bodies 34 is the retracted state. In other words, the rotational speed of the driven shaft 26 at which the overspeed detecting switch 21 detects abnormality in the speed of the car 8 (first preset overspeed) is a value that is lower when the state of the extensible bodies 34 is the extended state (when the direction of movement of the car 8 is downward) than when the state of the extensible bodies 34 is the retracted state (when the direction of movement of the car 8 is upward).

Now, if the extending and retracting operations of the extensible bodies 34 are not performed normally for any reason, and the state of each of the extensible bodies 34 is the extended state when the direction of movement of the car 8 is upward (i.e., when the state of each of the extensible bodies 34 should normally be the retracted state), or the state of each of the extensible bodies 34 is the retracted state when the direction of movement of the car 8 is downward (i.e., when the state of each of the extensible bodies 34 should normally be the extended state), the value of the first set overspeed may deviate from its original value, and an abnormality may occur in the speed governor 12.

The controlling apparatus 6 (FIG. 1) determines the presence or absence of an abnormality in the speed governor 12 by comparing the detection results of the operation detecting switches 31 with an elevator operational state that is determined by the direction of movement of the car 8. In other words, the controlling apparatus 6 determines the presence or absence of an abnormality in the speed governor 12 by comparing information concerning whether the direction of movement of the car 8 is upward or downward, and information concerning whether the operation detecting switches 31 are in the ON state or the OFF state.

Specifically, the controlling apparatus 6 determines that the speed governor 12 is normal if the operation detecting switches 31 are in the OFF state (the state of the extensible bodies 34 is the retracted state) when the direction of movement of the car 8 is upward, or if the operation detecting switches 31 are in the ON state (the state of the extensible bodies 34 is the extended state) when the direction of movement of the car 8 is downward. The controlling apparatus 6 determines that there is an abnormality in the speed governor 12 if the operation detecting switches 31 are in the ON state (the state of the extensible bodies 34 is the extended state) when the direction of movement of the car 8 is upward, or if the operation detecting switches 31 are in the OFF state (the state of the extensible bodies 34 is the retracted state) when the direction of movement of the car 8 is downward.

If it is determined that there is an abnormality in the speed governor 12, the control apparatus 6 issues a warning that urges inspection or repair, etc., using a sound or a display, or performs control that stops elevator operation, etc. Upon receiving a stopping signal from the overspeed detecting switch 21, the controlling apparatus 6 determines that an abnormality has arisen in the speed of the car 8, and performs control that stops elevator operation. The controlling apparatus 6 controls elevator operation based on respective information from the overspeed detecting switch 21 and each of the operation detecting switches 31.

The gripping apparatus 22 is disposed below the speed governor sheave 15 as shown in FIG. 4. The gripping apparatus 22 has: a fixed shoe 55 that is fixed to the supporting body 19; a movable shoe 56 that is displaceable between a gripping position that grips the speed governor rope 16 against the fixed shoe 55 and an open position that is further away from the fixed shoe 55 than the gripping position; a displacing pressing apparatus 57 that generates a gripping force that grips the speed governor rope 16 between the movable shoe 56 that has been displaced to the gripping position and the fixed shoe 55; and a holding apparatus 58 that holds the movable shoe 56 in the open position during normal operation, and that releases holding of the movable shoe 56 when the rotational speed of the driven shaft 26 reaches a second preset overspeed that is higher than the first preset overspeed.

The displacing pressing apparatus 57 has: a shoe compressible arm 59 that is connected between the mount portion that is disposed on the supporting body 19 and the movable shoe 56, and that can be extended and retracted; and a compressed spring (a forcing body) 60 that is disposed on the shoe compressible arm 59, and that forces the movable shoe 56 away from the mount portion of the supporting body 19.

The shoe compressible arm 59 is pivotably connected to both the mount portion of the supporting body 19 and the movable shoe 56. The movable shoe 56 is displaced between the gripping position and the open position by the shoe compressible arm 59 being pivoted relative to the mount portion of the supporting body 19. The shoe compressible arm 59 is pushed against the fixed shoe 55 and compressed when the movable shoe 56 is displaced to the gripping position. The shoe compressible arm 59 is subjected to the force of the compressed spring 60 and extended when the movable shoe 56 is displaced to the open position.

The compressed spring 60 is compressed between the mount portion of the supporting body 19 and the movable shoe 56. The compressed spring 60 is a coil spring through which the shoe compressible arm 56 has been passed internally. The force from the compressed spring 60 increases as the shoe compressible arm 59 is compressed.

A gripping force from the displacing pressing apparatus 57 arises due to the movable shoe 56 being displaced toward the gripping position, increasing the force from the compressed spring 60.

The holding apparatus 58 has: an engaging lever 61 that is displaceable between an engaged position that engages with the movable shoe 56 and a released position in which engagement with the movable shoe 56 is disengaged; a releasing spring (a forcing body) 62 that forces the engaging lever 61 in such a direction as to be displaced toward the released position; and a restraining member 63 that holds the engaging lever 61 in the engaged position in opposition to the force from the releasing spring 62.

The engaging lever 61 is displaced between the engaged position and the released position by being pivoted around a lever shaft 64 that is disposed on the supporting body 19. The releasing spring 62 is connected between the engaging lever 61 and the supporting body 19.

The restraining member 63 is pivotable around a supporting shaft 65 that is disposed on the supporting body 19. The restraining member 63 is linked to the displacing body 28 by means of a link 66. The restraining member 63 is thereby pivoted around the supporting shaft 65 in response to the displacement of the displacing body 28.

The link 66 is pivotably connected to both the displacing body 28 and the restraining member 63. The link 66 is displaced upward by an increase in the rotational speed of the driven shaft 26.

The engaging lever 61 is held in the engaged position by the restraining member 63 during normal operation. The restraining member 63 is pivoted by upward displacement of the link 66 in a direction in which holding of the engaging lever 61 by the restraining member 63 is disengaged. Holding of the engaging lever 61 by the restraining member 63 is disengaged when the rotational speed of the driven shaft 26 exceeds the first preset overspeed and reaches the second set overspeed.

When holding of the engaging lever 61 by the restraining member 63 is disengaged, the engaging lever 61 is displaced from the engaged position to the released position by the force of the releasing spring 62, releasing engagement between the movable shoe 56 and the engaging lever 61. When engagement between the movable shoe 56 and the engaging lever 61 is disengaged, the movable shoe 56 is displaced to the gripping position under its own weight, and the speed governor rope 16 is gripped between the fixed shoe 55 and the movable shoe 56.

Next, operation will be explained. When the car 8 is moved, the driven shaft 26 is rotated in response to the movement of the car 8, and the displacing body 28 is displaced parallel to the driven shaft 26 in response to the rotational speed of the driven shaft 26. If the car 8 is moved at normal operating speeds, displacement of the displacing body 28 is small, and the switch lever 54 is not operated by the operating portion 43.

If the speed of the car 8 increases and reaches the first set overspeed for any reason, the switch lever 54 is operated by the operating portion 43. A stopping signal is thereby sent to the controlling apparatus 6 from the overspeed detecting switch 21. When the controlling apparatus 6 receives the stopping signal, elevator operation is stopped forcibly by control from the controlling apparatus 6.

If the speed of the car 8 subsequently increases further and reaches the second set overspeed despite shutdown control being performed by the controlling apparatus 6, holding of the engaging lever 61 by the restraining member 63 is disengaged, and the speed governor rope 16 is gripped between the fixed shoe 55 and the movable shoe 56. Thus, movement of the speed governor rope 16 stops, and the car 8 is moved relative to the speed governor rope 16.

When the car 8 is moved relative to the speed governor rope 16, the operating arm 11 is operated, and an operation that grips the car guide rails is performed by the emergency stopper apparatus 10. A braking force is thereby applied directly to the car 8.

Next, operation of the sheave interlocking device 20 will be explained. When the car 8 ascends, the driven shaft 26 is rotated forward. A positive electric current is thereby generated by the generator 44. The positive electric current from the generator 44 passes through the rectifying apparatus 45 and is sent to the electromagnetic coils 41. The plungers 40 are thereby displaced to the retracted position, and the state of each of the extensible bodies 34 becomes the retracted state. In other words, when the direction of movement of the car 8 is upward, the fly balls 33 are orbited around the driven shaft 26 with the state of each of the extensible bodies 34 in the retracted state.

When the car 8 descends, the driven shaft 26 is rotated in reverse. Negative electric current is thereby generated by the generator 44. The negative electric current from the generator 44 is interrupted by the rectifying apparatus 45 and is not sent to the electromagnetic coils 41. The plungers 40 are thereby displaced to the extended position, and the state of each of the extensible bodies 34 becomes the extended state. In other words, when the direction of movement of the car 8 is downward, the fly balls 33 are orbited around the driven shaft 26 with the state of each of the extensible bodies 34 in the extended state.

Because the orbital radius of the fly balls 33 is greater during descent of the car 8 than during ascent, the respective rotational speeds of the driven shaft 26 for displacing the displacing body 28 to the position at which the switch lever 54 is operated, and to the position at which the restraining member 63 is displaced to the released position, are lower during descent of the car 8 than during ascent. In other words, the first and second preset overspeeds are lower during descent of the car 8 than during ascent.

Next, an operation for determining the presence or absence of an abnormality in the speed governor 12 will be explained. The information from the operation detecting switches 31 is constantly sent to the controlling apparatus 6. Determination of the presence or absence of abnormalities in the speed governor 12 is constantly performed in the controlling apparatus 6 by comparing the information from the operation detecting switches 31 and the direction of movement of the car 8.

Specifically, if the state of each of the extensible bodies 34 is the retracted state when the car 8 ascends, or if the state of each of the extensible bodies 34 is the extended state when the car 8 descends, then a determination that the speed governor 12 is normal is performed by the controlling apparatus 6.

If the respective extensible bodies 34 are not retracted during ascent of the car 8 for any reason, and the state of the respective extensible bodies 34 remains the extended state, or if the respective extensible bodies 34 do not extend during descent of the car 8 for any reason, and the state of the respective extensible bodies 34 remains the retracted state, a determination that there is an abnormality in the speed governor 12 is performed by the controlling apparatus 6.

If a determination that there is an abnormality in the speed governor 12 is performed by the controlling apparatus 6, a warning that urges inspection, etc., is issued, and elevator operation is also stopped, under control from the controlling apparatus 6.

In an elevator apparatus of this kind, because whether the state of the extensible bodies 34 is an extended state or a retracted state is detected by the operation detecting switches 31, even if the extensible bodies 34 are not able to perform normal extending and retracting operations, abnormalities in the speed governor 12 can be more reliably detected by comparing the detection results of the operation detecting switches 31 and the elevator operational state. Thus, abnormalities in the speed governor 12 can be detected early, enabling elevator operation to be prevented from being continued in a state in which an abnormality has arisen in the speed governor 12.

Because the operation detecting switches 31 have: switch main bodies 51; and switch movable segments 52 that are displaced between an advanced position and a regressed position in response to the expansion and contraction of the extensible bodies 34, and the switch main bodies 51 detect whether the state of the extensible bodies 34 is the extended state or the retracted state by the displacement of the switch movable segments 52, the state of the extensible bodies 34 can be detected by a simple construction and more reliably.

Because the extensible bodies 34 are extended and retracted in response to an elevator operational state that is determined by the direction of movement of the car 8, the state of the extensible bodies 34 is set to mutually different states that are the extended state and the retracted state, when the direction of movement of the car 8 is upward, and when it is downward, enabling the orbital radius of the fly balls 33 to be made different during ascent and during descent of the car 8. Thus, first and second preset overspeeds for detecting abnormalities in the speed of the car 8 can be set separately during ascent and during descent of the car 8.

Moreover, in the above example, the state of the extensible bodies 34 is set to the retracted state when the direction of movement of the car 8 is upward, and the state of the extensible bodies 34 is set to the extended state when the direction of movement of the car 8 is downward, but the state of the extensible bodies 34 may also be set to the extended state when the direction of movement of the car 8 is upward, and the state of the extensible bodies 34 set to the retracted state when the direction of movement of the car 8 is downward.

### Embodiment 2

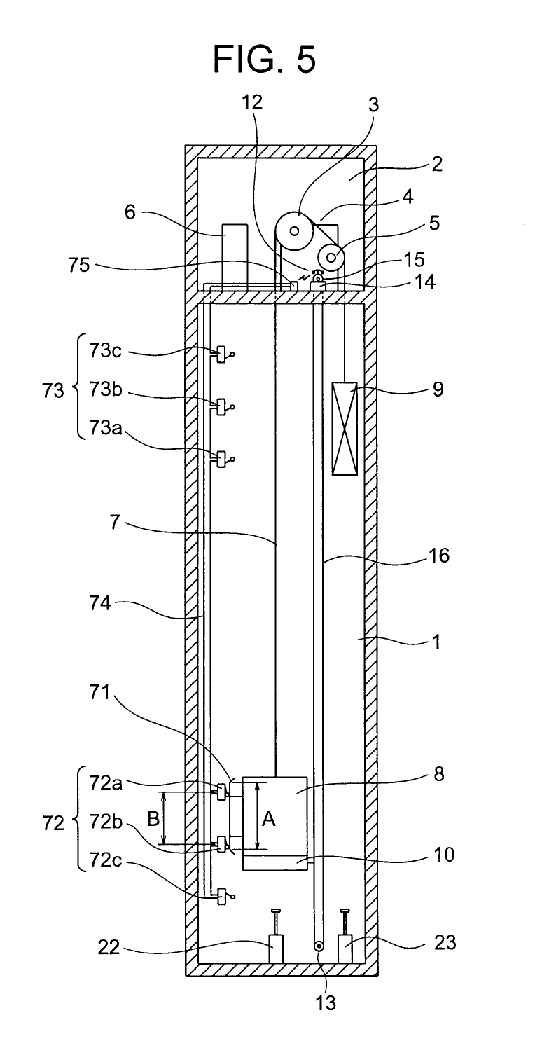

FIG. 5 is a configuration diagram that shows an elevator apparatus according to Embodiment 2 of the present invention. In the figure, a cam (a detected body) 71 that is parallel to a direction of movement of a car 8 is disposed on a side surface of the car 8. A predetermined lower end portion region that is positioned in a lower end portion (a terminal portion) of the hoistway 1 and a predetermined upper end portion region that is positioned in an upper end portion (a terminal portion) of the hoistway 1 are set inside the hoistway 1. The lower end portion region and the upper end portion region are regions that have predetermined lengths in the direction of movement of the car 8. A lower end car position detecting apparatus 72 that detects the presence or absence of the car 8 in the lower end portion region, and an upper end car position detecting apparatus 73 that detects the presence or absence of the car 8 in the upper end portion region are disposed inside the hoistway 1.

The lower end car position detecting apparatus 72 has a plurality of (in this example, three) lower portion position switches 72a, 72b, and 72c that can detect the cam 71. Each of the lower portion position switches 72a through 72c is disposed in a lower portion inside the hoistway 1. The lower portion position switches 72a through 72c are disposed so as to be spaced apart from each other in the direction of movement of the car 8.

The upper end car position detecting apparatus 73 has a plurality of (in this example, three) upper portion position switches 73a, 73b, and 73c that can detect the cam 71. Each of the upper portion position switches 73a through 73c is disposed in a upper portion inside the hoistway 1. The upper portion position switches 73a through 73c are disposed so as to be spaced apart from each other in the direction of movement of the car 8.

At least one of the lower portion position switches 72a through 72c is operated by the cam 71 when the car 8 is in the lower end portion region. At least one of the upper portion position switches 73a through 73c is operated by the cam 71 when the car 8 is in the upper end portion region. The respective lower portion position switches 72a through 72c and the respective upper portion position switches 73a through 73c detect the cam 71 by being operated by the cam 71. When the car 8 is in an intermediate portion inside the hoistway 1 so as to be outside both the lower end portion region and the upper end portion region, operation by the cam 71 is released on all of the lower portion position switches 72a through 72c and the upper portion position switches 73a through 73c.

In other words, the lower end car position detecting apparatus 72 detects the presence or absence of the car 8 in the lower end portion region by the presence or absence of detection of the cam 71 by the respective lower portion position switches 72a through 72c. The upper end car position detecting apparatus 73 detects the presence or absence of the car 8 in the upper end portion region by the presence or absence of detection of the cam 71 by the respective upper portion position switches 73a through 73c.

Respective spacing B between the lower portion position switches 72a through 72c and between the upper portion position switches 73a through 73c is narrower than a length A of the cam 71. Thus, a state in which none of the lower portion position switches 72a through 72c can detect the cam 71 when the car 8 is moved through the lower end portion region is prevented from occurring. A state in which none of the upper portion position switches 73a through 73c can detect the cam 71 when the car 8 is moved through the upper end portion region is also prevented from occurring.

The lower portion position switches 72a through 72c and the upper portion position switches 73a through 73c are connected in series by electric wires 74. The electric wires 74 are connected to a communications device 75 that is disposed inside the machine room 2. The communications device 75 performs information communication with the speed governor main body 14 by radio based on the respective detection states of each of the lower portion position switches 72a through 72c and each of the upper portion position switches 73a through 73c.

Moreover, in FIG. 5, a state is shown in which the car 8 is present in the lower end portion region, and two lower portion position switches 72a and 72b are simultaneously detecting the cam 71.

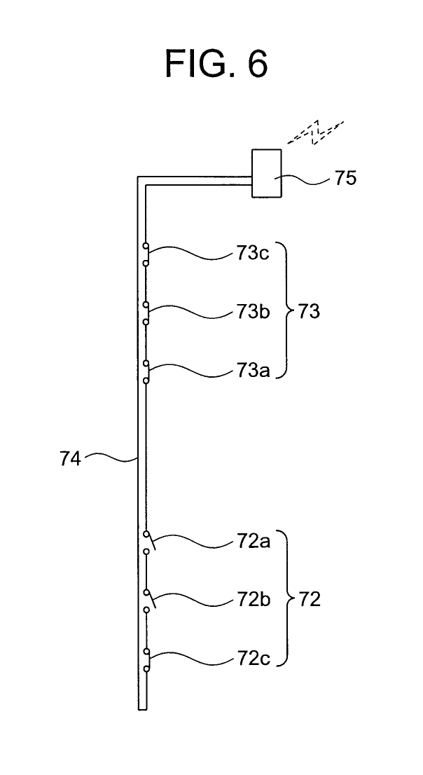

FIG. 6 is a circuit diagram that shows electrically connected states of the lower portion position switches 72a through 72c, the upper portion position switches 73a through 73c, and the communications device 75 from FIG. 5.

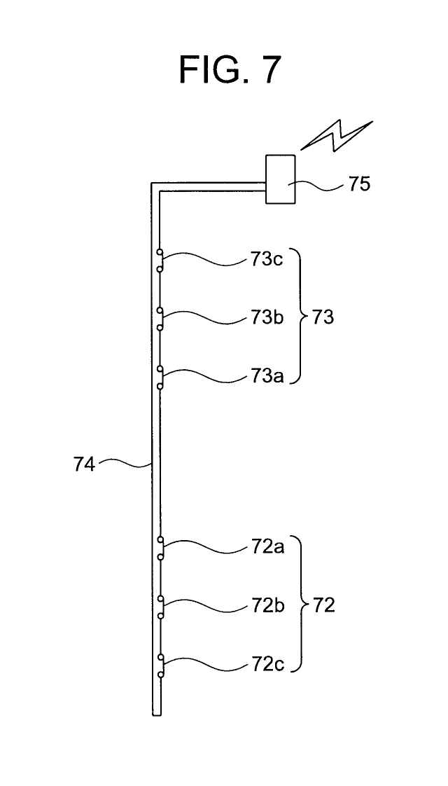

FIG. 7 is a circuit diagram that shows a state in which all of the lower portion position switches 72a through 72c and the upper portion position switches 73a through 73c from FIG. 6 have stopped cam detection. Moreover, FIG. 6 is a diagram that shows a state in which only two lower portion position switches 72a and 72b are detecting the cam 71.

In the figures, the lower portion position switches 72a through 72c and the upper portion position switches 73a through 73c each have a contact that opens and closes in response to the presence or absence of detection of the cam 71. The contacts of the lower portion position switches 72a through 72c and the upper portion position switches 73a through 73c open on detection of the cam 71, and close when detection of the cam 71 stops.

Thus, when all of the lower portion position switches 72a through 72c and the upper portion position switches 73a through 73c have stopped detecting the cam 71, all of the contacts are closed as shown in FIG. 7, and a radio signal is output from the communications device 75 to the speed governor main body 14. When at least one of the lower portion position switches 72a through 72c or the upper portion position switches 73a through 73c is detecting the cam 71, some of the contacts are open as shown in FIG. 6, and the output of the radio signal from the communications device 75 is stopped.

In other words, when the car 8 is outside both the upper end portion region and the lower end portion region, the radio signal is output from the communications device 75 to the speed governor main body 14 (FIG. 3), and when the car 8 is present in either the upper end portion region or the lower end portion region, the output of the radio signal from the communications device 75 is stopped (FIG. 2).

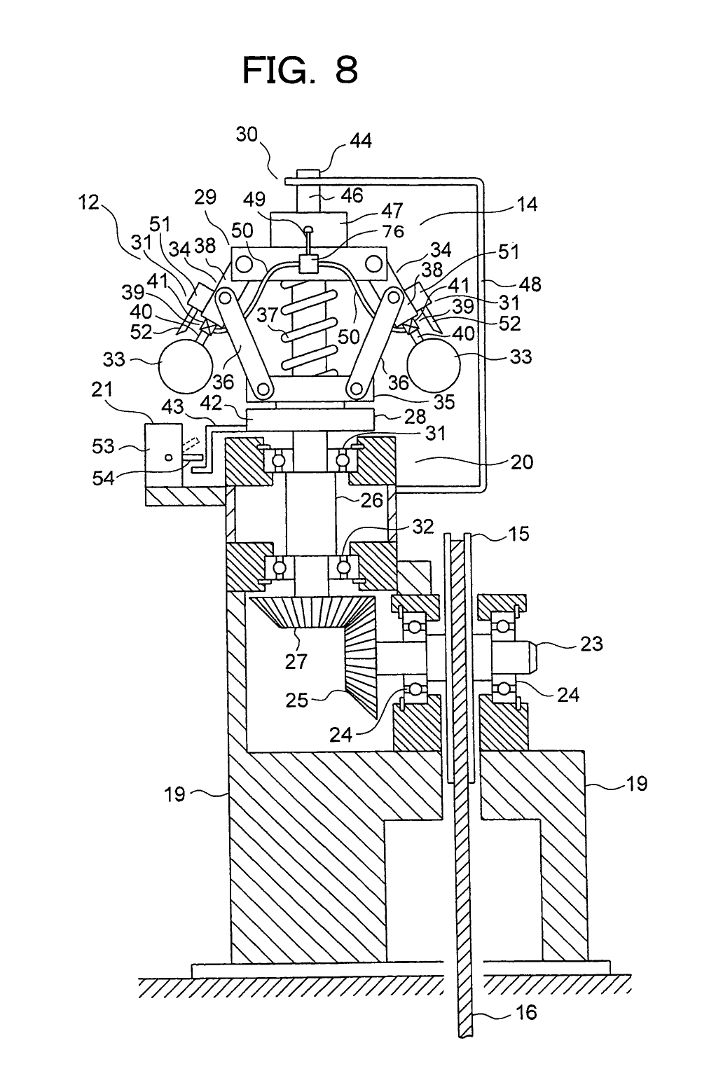

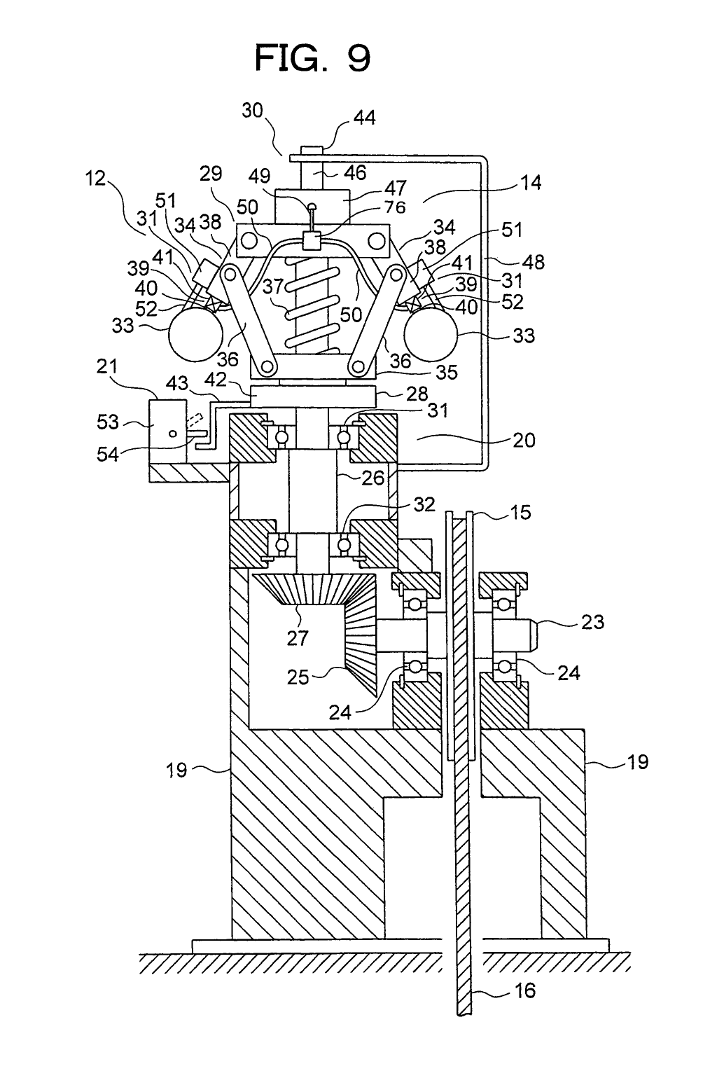

FIG. 8 is a longitudinal cross section that shows a speed governor 12 from FIG. 5. FIG. 9 is a longitudinal cross section that shows the speed governor 12 from FIG. 5 when a car 8 is outside both the lower end portion region and the upper end portion region. In the figure, the switching apparatus 30 switches the setting of the centrifugally displacing apparatus 29 in response to the operating state of the elevator, which is determined by the presence or absence of the car 8 in the upper end portion region or the lower end portion region. Specifically, the switching apparatus 30 switches the setting of the centrifugally displacing apparatus 29 between when the car 8 is either in the upper end portion region or in the lower end portion region, and when the car 8 is outside both the upper end portion region and the lower end portion region. By switching the setting of the centrifugally displacing apparatus 29, the switching apparatus 30 modifies the relationship between the rotational speed of the driven shaft 26 and the amount of displacement of the displacing body 28. The setting of the centrifugally displacing apparatus 29 is switched by extending and retracting the respective extensible bodies 34.

The switching apparatus 30 extends and retracts the extensible bodies 34 based on the information (the radio signal) from the communications device 75. Specifically, the switching apparatus 30 sets the state of the extensible bodies 34 to mutually different states that are the extended state and the retracted state, when the radio signal from the communications device 75 is received (i.e., when the car 8 is outside both the upper end portion region and the lower end portion region), and when the radio signal is not received (i.e., when the car 8 is in either the upper end portion region or the lower end portion region). Thus, the orbital radius of the fly balls 33 is different, and thus the relationship between the rotational speed of the driven shaft 26 and the amount of displacement of the displacing body 28 is different, when the car 8 is either in the upper end portion region or in the lower end portion region, and when the car 8 is outside both the upper end portion region and the lower end portion region.

In this example, the switching apparatus 30 sets the state of the extensible bodies 34 to the extended state when the car 8 is in either the upper end portion region or the lower end portion region (i.e., when receipt of the radio signal from the communications device 75 is stopped), and sets the state of the extensible bodies 34 to the retracted state when the car 8 is outside both the upper end portion region and the lower end portion region (i.e., when the radio signal from the communications device 75 is received).

The switching apparatus 30 has: a generator 44 that is similar or identical to that of Embodiment 1; and a switching circuit 76 that controls the electric power that is sent from the generator 44 to the electromagnetic coils 41 based on the information from the communications device 75.

The switching circuit 76 is electrically connected to the generator main body 47 and the electromagnetic coils 41 by conducting wires 49 and 50, respectively. Of the electric power that is generated by the generator 44, the switching circuit 76 only sends electric power to the electromagnetic coils 41 either when the car 8 is in either the upper end portion region or the lower end portion region, or when the car 8 is outside both the upper end portion region and the lower end portion region.

In this example, the electric current from the generator 44 is only sent to the electromagnetic coils 41 by the switching circuit 76 when the car 8 is outside both the upper end portion region and the lower end portion region (i.e., when the radio signal is received from the communications device 75). Consequently, the state of the extensible bodies 34 is set to the extended state when the car 8 is in either the upper end portion region or the lower end portion region, and the state of the extensible bodies 34 is set to the retracted state when the car 8 is outside both the upper end portion region and the lower end portion region.

If the extending and retracting operations of the extensible bodies 34 are not performed normally for any reason, and the state of each of the extensible bodies 34 is the extended state when the car 8 is outside both the upper end portion region and the lower end portion region (i.e., when the state of each of the extensible bodies 34 should normally be the retracted state), or the state of each of the extensible bodies 34 is the retracted state when the car 8 is in either the upper end portion region or the lower end portion region (i.e., when the state of each of the extensible bodies 34 should normally be the extended state), the value of the first set overspeed may deviate from its original value, and an abnormality may occur in the speed governor 12.

The controlling apparatus 6 (FIG. 5) determines the presence or absence of an abnormality in the speed governor 12 by comparing the detection results of the operation detecting switches 31 with an elevator operational state that is determined by the presence or absence of the car 8 in the upper end portion region or the lower end portion region. In other words, the controlling apparatus 6 determines the presence or absence of an abnormality in the speed governor 12 by comparing information concerning whether or not the car 8 is in either the upper end portion region or the lower end portion region, and information concerning whether the operation detecting switches 31 are in the ON state or the OFF state.

Specifically, the controlling apparatus 6 determines that the speed governor 12 is normal if the operation detecting switches 31 are in the OFF state (the state of the extensible bodies 34 is the retracted state) when the car 8 is outside both the upper end portion region and the lower end portion region, or if the operation detecting switches 31 are in the ON state (the state of the extensible bodies 34 is the extended state) when the car 8 is in either the upper end portion region or the lower end portion region. The controlling apparatus 6 determines that there is an abnormality in the speed governor 12 if the operation detecting switches 31 are in the ON state (the state of the extensible bodies 34 is the extended state) when the car 8 is outside both the upper end portion region and the lower end portion region, or if the operation detecting switches 31 are in the OFF state (the state of the extensible bodies 34 is the retracted state) when the car 8 is in either the upper end portion region or the lower end portion region. Other functions of the controlling apparatus 6 are similar or identical to those of Embodiment 1.

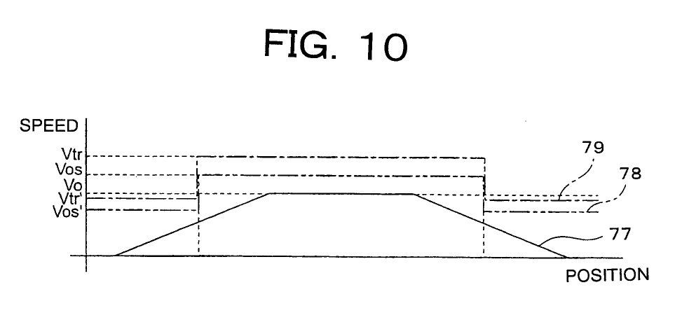

FIG. 10 is a graph that shows relationships between normal operating speed, a first set overspeed, and a second set overspeed, respectively, of the car 8 from FIG. 5 and position of the car 8. As shown in the figure, the value of the first set overspeed 78 (the speed of the car 8 when the overspeed detecting switch 21 outputs the stopping signal) is a value that is higher than the normal operating speed 77 of the car 8 at all positions to which the car 8 moves. The value of the second set overspeed 79 (the speed of the car 8 when the emergency stopper apparatus 10 is activated due to gripping of the speed governor rope 16 by the speed governor main body 14) is a value that is higher than the value of the first set overspeed 78 at all positions through which the car 8 moves.

Since the state of the extensible bodies 34 changes between the extended state and the retracted state depending on whether or not the car 8 is in either the upper end portion region or the lower end portion region, the value of the first set overspeed 78 is a first terminal portion reference value V_{os′} that is lower than a rated speed value V₀ of the elevator when the car 8 is in either the upper end portion region or the lower end portion region, and is a first intermediate portion reference value Vₒₛ that is higher than the rated speed value V₀ of the elevator (a value that is 1.3 times the rated speed, for example) when the car 8 is outside both the upper end portion region and the lower end portion region.

Since the state of the extensible bodies 34 changes between the extended state and the retracted state depending on whether or not the car 8 is in either the upper end portion region or the lower end portion region, the value of the second set overspeed 79 is a second terminal portion reference value V_{tr′} that is lower than the rated speed value V₀ of the elevator and higher than the first terminal portion reference value V_{os′} when the car 8 is in either the upper end portion region or the lower end portion region, and is a second intermediate portion reference value Vₜᵣ that is higher than the first intermediate portion reference value Vₒₛ when the car 8 is outside both the upper end portion region and the lower end portion region. The rest of the configuration is similar or identical to that of Embodiment 1.

Next, operation will be explained. If the car 8 is moved at the normal operating speed 77, elevator operation will not be stopped forcibly, because the speed of the car 8 will not reach the first and second set overspeeds 78 and 79.

If the speed of the car 8 increases and reaches the first set overspeed 78 for any reason, a stopping signal is sent to the control apparatus 6 from the overspeed detecting switch 21. When the control apparatus 6 receives the stopping signal, elevator operation is stopped forcibly by the control apparatus 6.

If the speed of the car 8 subsequently increases further and reaches the second set overspeed 79 despite shutdown control being performed by the control apparatus 6, then the speed governor rope 16 is gripped by the speed governor 12. Thus, movement of the speed governor rope 16 stops, and the car 8 is displaced relative to the speed governor rope 16.

When the car 8 is displaced relative to the speed governor rope 16, the operating arm 11 is operated, and an operation that grips the car guide rails is performed by the emergency stopper apparatus 10. A braking force is thereby applied directly to the car 8.

Next, operation when the values of the first and second preset overspeeds 78 and 79 are switched over will be explained. When the car 8 is in the intermediate portion of the hoistway 1 (i.e., when the car 8 is outside both the upper end portion region and the lower end portion region), none of the lower portion position switches 72a through 72c or the upper portion position switches 73a through 73c detect the cam 71. At this time, the radio signal is sent from the communications device 75 to the switching circuit 76, and supply of electric power from the generator 44 to the respective electromagnetic coils 41 is performed by means of the switching circuit 76.

When electric power is supplied to the respective electromagnetic coils 41, each of the extensible bodies 34 contracts, and the state of each of the extensible bodies 34 is the retracted state. The orbital radius of the fly balls 33 is thereby reduced, setting the value of the first set overspeed 78 to the first intermediate portion reference value Vₒₛ, and setting the value of the second set overspeed 79 to the second intermediate portion reference value Vₜᵣ.

If the car 8 moves and enters either the upper end portion region or the lower end portion region from the intermediate portion of the hoistway 1, one of the respective lower portion position switches 72a through 72c or the respective upper portion position switches 73a through 73c detects the cam 71. Output of the radio signal from the communications device 75 is thereby stopped, and the supply of electric power to each of the electromagnetic coils 41 is stopped.

When the supply of electric power to each of the electromagnetic coils 41 is stopped, each of the extensible bodies 34 extends, increasing the length of each of the extensible bodies 34. The orbital radius of the fly balls 33 is thereby increased, switching the value of the first set overspeed 78 over to the first terminal portion reference value V_{os′}, which is lower than the first intermediate portion reference value Vₒₛ, and switching the value of the second set overspeed 79 over to the second terminal portion reference value V_{tr′}, which is lower than the second intermediate portion reference value Vₜᵣ.

If the car 8 enters the intermediate portion of the hoistway 1 from either the upper end portion region or the lower end portion region, the value of the first set overspeed 78 is switched over from the first terminal portion reference value V_{os′} to the first intermediate portion reference value Vₒₛ, and the value of the second set overspeed 79 is switched over from the second terminal portion reference value V_{tr′} to the second intermediate portion reference value Vₜᵣ by a reverse operation to the above.

Next, an operation for determining the presence or absence of an abnormality in the speed governor 12 will be explained. The information from the operation detecting switches 31 is constantly sent to the controlling apparatus 6. Determination of the presence or absence of abnormalities in the speed governor 12 is constantly performed in the controlling apparatus 6 by comparing the information from the operation detecting switches 31 and information concerning the presence or absence of the car 8 in the upper end portion region and the lower end portion region.

Specifically, if the state of each of the extensible bodies 34 is the retracted state when the car 8 is outside both the upper end portion region and the lower end portion region, or if the state of each of the extensible bodies 34 is the extended state when the car 8 is in either the upper end portion region or the lower end portion region, then a determination that the speed governor 12 is normal is performed by the controlling apparatus 6.

If the respective extensible bodies 34 are not retracted for any reason when the car 8 enters the intermediate portion of the hoistway 1, and the state of the respective extensible bodies 34 remains the extended state, or if the respective extensible bodies 34 do not extend for any reason when the car 8 enters either the upper end portion region or the lower end portion region, and the state of the respective extensible bodies 34 remains the retracted state, a determination that there is an abnormality in the speed governor 12 is performed by the controlling apparatus 6.

If a determination that there is an abnormality in the speed governor 12 is performed by the controlling apparatus 6, a warning that urges inspection, etc., is issued, and elevator operation is also stopped, under control from the controlling apparatus 6.

In an elevator apparatus of this kind, because the extensible bodies 34 are extended and retracted in response to the elevator operational state that is determined by the presence or absence of the car 8 in either the upper end portion region or the lower end portion region, and the state of the extensible bodies 34 is set to mutually different states that are the extended state and the retracted state, when the car 8 is in either the upper end portion region or the lower end portion region, and when the car 8 is outside both the upper end portion region and the lower end portion region, the orbital radius of the fly balls 33 can be set so as to be different depending on the presence or absence of the car 8 in the upper end portion region or the lower end portion region. The first and second preset overspeeds for detecting abnormalities in the speed of the car 8 can thereby be set separately when the car 8 is in either the upper end portion region or the lower end portion region, and when the car 8 is outside both the upper end portion region and the lower end portion region. Consequently, the car 8 can be stopped forcibly at a stage when the speed of the car 8 is lower at positions close to terminal portions of the hoistway 1 than when the car 8 is in the intermediate portion of the hoistway 1, enabling the deceleration distance of the car 8 to be shortened. Thus, size reductions in the car buffer 17 and the counterweight buffer 18 can be achieved, enabling size reductions in the hoistway 1.

Moreover, in the above example, information as to whether or not the car 8 is in either the upper end portion region or the lower end portion region is sent to the switching circuit 76 using the radio signal from the communications device 75, but information as to whether or not the car 8 is in either the upper end portion region or the lower end portion region may also be sent to the switching circuit 76 using a cable. In that case, two brushes are connected to a first end portion and a second end portion of the electric wire 74 instead of the communications device 75, and two sliding portions that the respective brushes contact are disposed on the driven shaft 26. The respective sliding portions are electrically connected to the switching circuit 76. The information as to whether or not the car 8 is in either the upper end portion region or the lower end portion region is sent to the switching circuit 76 through the respective brushes and the respective sliding portions.

In the above example, the respective values of the first and second preset overspeeds 78 and 79 when the car 8 is in either the upper end portion region or the lower end portion region are values that are lower than the rated speed value V₀ of the elevator, but the value of only the second set overspeed 79 when the car 8 is in either the upper end portion region or the lower end portion region may be a value that is higher than the rated speed value V₀ of the elevator, or the respective values of the first and second preset overspeeds 78 and 79 may both be values that are higher than the rated speed value V₀ of the elevator.

In each of the above embodiments, electric power that is generated by the generator 44 is sent to the electromagnetic coils 41, but electric power that is supplied from a commercial power supply, or a battery, etc., may also be sent to the electromagnetic coils 41, for example.

In each of the above embodiments, the switch movable segments 52 are separated from the fly balls 33 when the state of the extensible bodies 34 is the extended state, and the switch movable segments 52 are pressed against the fly balls 33 when the state of the extensible bodies 34 is the retracted state, but the switch movable segments 52 may also be connected to the fly balls 33 and the switch movable segments 52 and the fly balls 33 displaced together. The switch movable segments 52 may also be connected to the plungers 40. The switch movable segments 52 can also be displaced in response to the extension and retraction of the extensible bodies 34 if configured in this manner.

1-4. (canceled)

5. An elevator apparatus, comprising:
a car that is moved inside a hoistway;
a speed governor comprising:
a centrifugal weight that revolves around a predetermined revolving shaft in response to the movement of the car;
an extensible body to which the centrifugal weight is connected, and that is rotated around the revolving shaft, the extensible body being displaced relative to the revolving shaft in response to a centrifugal force to which the centrifugal weight is subjected due to the revolution;
a switching apparatus that extends and retracts the extensible body in response to an elevator operational state; and
an operation detecting apparatus that detects whether a state of the extensible body is an extended state in which the extensible body is extended or a retracted state in which the extensible body is retracted,
the speed governor detecting presence or absence of an abnormality in speed of the car based on an amount of displacement of the extensible body relative to the revolving shaft; and
a controlling apparatus that determines presence or absence of an abnormality in the speed governor by comparing the elevator operational state and detection results from the operation detecting apparatus.

6. The elevator apparatus according to claim 5, wherein
the operation detecting apparatus comprises:
an operation detecting apparatus main body that is disposed on the extensible body; and
a movable body that is displaceable between an advanced position that protrudes outward from the operation detecting apparatus main body and a regressed position that is closer to the operation detecting apparatus main body than the advanced position;
the movable body is displaced between the advanced position and the regressed position in response to the extension and retraction of the extensible body; and
the operation detecting apparatus main body detects whether the state of the extensible body is the extended state or the retracted state by the displacement of the movable body.

7. The elevator apparatus according to claim 5, wherein
the elevator operational state is determined by a direction of the movement of the car; and
the switching apparatus sets the state of the extensible body to mutually different states that are the extended state and the retracted state when the direction of movement of the car is upward, and when the direction of movement of the car is downward.

8. The elevator apparatus according to claim 6, wherein
the elevator operational state is determined by a direction of the movement of the car; and
the switching apparatus sets the state of the extensible body to mutually different states that are the extended state and the retracted state when the direction of movement of the car is upward, and when the direction of movement of the car is downward.

9. The elevator apparatus according to claim 5, wherein
the elevator operational state is determined by presence or absence of the car in a predetermined region that is set inside the hoistway; and
the switching apparatus sets the state of the extensible body to mutually different states that are the extended state and the retracted state when the car is present in the predetermined region, and when the car is outside predetermined region.

10. The elevator apparatus according to claim 6, wherein
the elevator operational state is determined by presence or absence of the car in a predetermined region that is set inside the hoistway; and
the switching apparatus sets the state of the extensible body to mutually different states that are the extended state and the retracted state when the car is present in the predetermined region, and when the car is outside predetermined region.
